(19) United States
(12) Patent Application Publication
(10) Pub. No.: US 2016/0160459 A1
(43) Pub. Date: Jun. 9, 2016

(54) ARRESTING FENCE SYSTEM

(71) Applicant: Engineered Arresting Systems Corporation, Aston, PA (US)

(72) Inventor: Richard L. Orner, JR., Oreland, PA (US)

(21) Appl. No.: 14/959,270

(22) Filed: Dec. 4, 2015

Related U.S. Application Data
(60) Provisional application No. 62/088,001, filed on Dec. 5, 2014.

(51) Int. Cl. E01F 13/12; E01F 13/08; E06B 11/02; E01F 13/10

(52) U.S. Cl. CPC E01F 13/12; E01F 13/10; E01F 13/08; E06B 11/021

(57) ABSTRACT

Embodiments of the present disclosure relate generally to an arresting fence system that is deployable in order to bring a traveling vehicle to a stop through controlled deceleration. An arresting system (including an arrestor net, an energy absorber, and a release mechanism) is integral to a gate carriage that may be movable in order to position the fence system in the desired position. The gate carriage can be incorporated into a new or existing fence to restrict access to a desired location.

### CROSS REFERENCE TO RELATED APPLICATIONS

This application claims the benefit of U.S. Provisional Application Ser. No. 62/088,001, filed Dec. 5, 2014, titled “Movable Arresting System Fence,” the entire contents of which are hereby incorporated by reference.

### FIELD OF THE DISCLOSURE

Embodiments of the present disclosure relate generally to an arresting fence system that is deployable in order to bring a traveling vehicle to a stop through controlled deceleration. An arresting system (including an arrestor net, an energy absorber, and a release mechanism) is integral to a gate carriage that may be movable in order to position the fence system in the desired position. The gate carriage can be incorporated into a new or existing fence to restrict access to a desired location.

### BACKGROUND

There may be instances when it is desirable to stop a moving vehicle. For example, systems to arrest vehicles may find use in connection with restricted government or military locations. Systems may also find use in various commercial applications. In some instances, spikes that can deflate the vehicle's tires may be used, but such systems are generally not portable. Tire deflation barriers can also allow the vehicle to drive a substantial distance past the barrier. If the vehicle tires are puncture resistant, such a system will not stop the vehicle at all. In other instances, concrete barriers may be used. However, such barriers can require expensive installation equipment and are not easily moved. Because concrete barriers often rely on their own weight to prevent or stop a traveling vehicle, their size and mass can prevent their successful use in a mobile or emergency situation.

Other vehicle stopping solutions have been to provide a lowering boom that can raise and lower between an up position and a down position or that can extend and retract between deployed and undeployed positions. However, such booms can be broken and avoided if an approaching vehicle is traveling up to and past the boom at a sufficient vehicle speed. Further vehicle stopping systems may use a net that is raised or lowered from the roadway surface (or from beneath the roadway surface). For example, there are systems that raise a net above the roadway, stowing the net in a tower structure. The overhead towers can require clearances from existing telephone poles, power cable systems, or other structures. They can also be subject to Department of Transportation structural design constraints. In use, the nets may be lowered onto the roadway. However, such nets often require complicated or extensive recesses to be installed below the surface, necessitating extensive excavation. Additionally, such nets are not always movable or deployable in a desired location. Arresting systems that use nets are generally permanent in nature, such that posts are installed in the ground with a net extending therebetween. The posts are generally installed with a concrete footing. In other examples, the posts may be anchored to structures, such as trailers or trees. These systems are not designed to be moveable or deployable in a desired location.

Vertical pivot gates also exist. These gates may be crash resistant, meaning that they can withstand the impact of a moving vehicle. However, these gates do not allow for any vehicle run out. Their goal is to stop a moving vehicle in the shortest distance possible and do not consider any effects that can result in damage to the vehicle and potential injury to vehicle occupants.

Accordingly, there is a need for a movable, lightweight, and quickly deployable vehicle arresting fence system that can effectively stop a moving vehicle without injuring the vehicle occupants or others in the vicinity, and without causing substantial property damage.

### BRIEF SUMMARY

Embodiments of the invention described herein thus provide systems and methods for an arresting fence system. In one example, there is provided a vehicle arresting system, comprising: a gate carriage configured for movement into and out of a path to be blocked, the gate carriage comprising: an arrestor net configured to engage a moving vehicle, one or more release mechanisms for releasing the arrestor net upon a specified load; one or more energy absorbers associated with the net; and one or more gate carriage restraints for securing the gate carriage in place. The one or more gate carriage restraints may comprise arrestment restraints. The one or more gate carriage restraints may comprise a roadway channel.

In another example, there is provided a method of arresting the vehicle, comprising: moving a movable arresting system fence into a closed path position; capturing a movable vehicle via the fence.

In a further embodiment, there is provided a vehicle arrestment system for use in connection with a fencing system, comprising: a movable gate carriage configured for movement into and out of an opening defined by the fencing system to be blocked, the movable gate carriage comprising: an arrestor net configured to engage a moving vehicle, one or more release mechanisms for releasing the arrestor net upon a specified load; one or more energy absorbers associated with the net; a moving system configured to cause movement of the movable gate carriage into and out of a blocking position with respect to the opening; and one or more gate carriage restraints for securing the gate carriage in place.

### BRIEF DESCRIPTION OF THE DRAWINGS

FIG. 1 shows a front perspective view of one embodiment of a movable arresting system fence.

FIG. 2 shows a front perspective of an alternate embodiment of a movable arresting system fence.

FIGS. 3A and 3B show front plan views of a fencing system incorporating a movable fence. FIG. 3A illustrates the movable fence and a clear path position. FIG. 3B illustrates the movable fence in a closed path position.

FIG. 4 show views of a vehicle being stopped by the movable fence system described herein. FIG. 4A shows a front plan view of the movable fence system in a ready/closed path position. FIG. 4B shows a front plan view of a vehicle making contact with the fence. FIG. 4C shows a top plan view of a vehicle making contact with the fence with the one or more energy absorbers activated.

FIG. 5 shows a side view of a roadway channel that may receive an arresting fence system described herein.

### DETAILED DESCRIPTION

Embodiments of the present invention provide an arresting fence system 10. In certain embodiments, the fence system 10 may be movable or deployable upon demand. It may have rollers or a pivoting system that can facilitate movement of the fence system 10 with respect to a more permanent fencing system. The fence system 10 is designed to bring a traveling vehicle to a stop through controlled deceleration. In use, the fence 10 may be positioned across a restricted area or other area into which vehicle traffic should be halted. The fence 10 is configured to be movable, such that it can be re-positioned as desired.

In general, the arresting fence system 10 may include a net secured to one or more energy absorbers that bring the vehicle to a stop. In use, the net is engaged by the vehicle and is released via release mechanism such that the net then envelopes the vehicle. The energy absorber can transmit a restraining force through the net to the vehicle, bringing it to a stop within the desired distance.

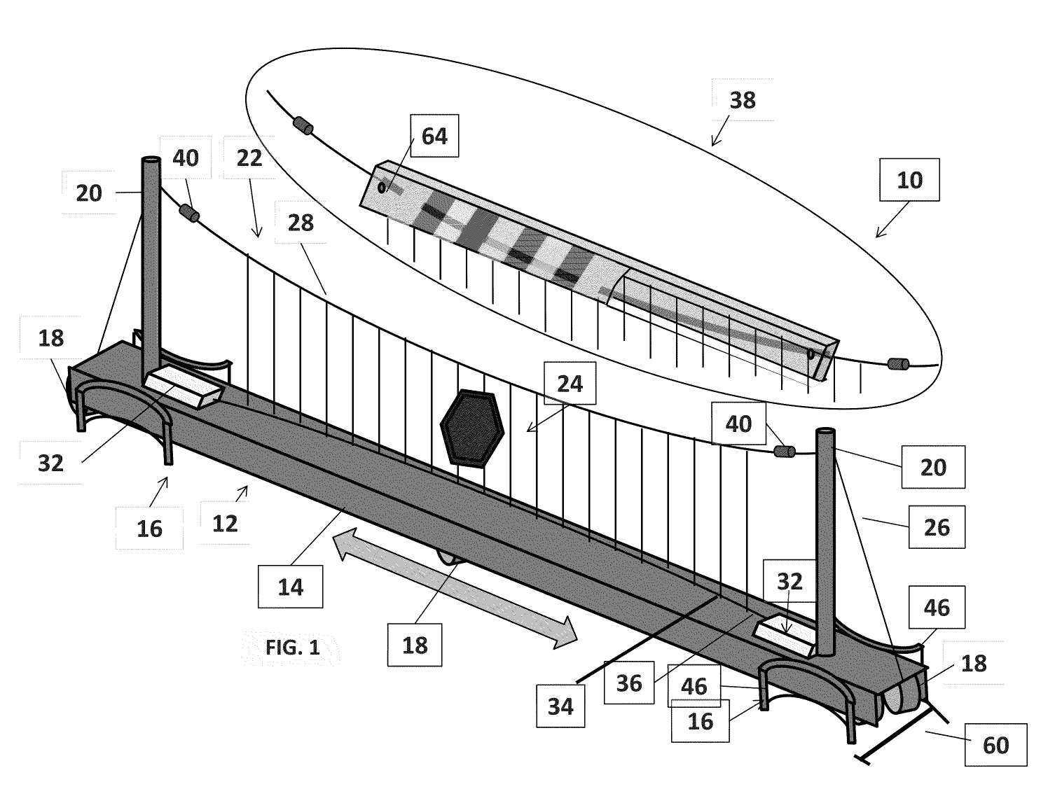

As illustrated by FIG. 1, the arresting fence system 10 may generally include components mounted on a movable gate carriage 12. The movable gate carriage 12 may include a channel section 14 that can extend between arrestment restraints 16. In one example, the channel section 14 can roll between secured arrestment restraints 16. In another example, an arrestment restraint 16 may be positioned at either end of the channel section 14 and move therewith. The arrestment restraints 16 can help secure the gate carriage 12 of the arrestment fence system 10 once it has been located in the desired position.

In one example, the arrestment restraints 16 may include first and second elements 46 positioned with a space 60 therebetween. In use, ends of the movable gate carriage 12 may be moved laterally into the space 48 between the arrestment elements 46 in order to provide a barrier to entry to the area to be protected. The movable gate carriage 12 may be moved via rolling. For example, the gate carriage 12 may roll laterally into the space 60 created between arrestment restraints 16. In order to position the fence 10, one or more rollers 18 may be positioned along the channel section 14. In one example, one or more rollers 18 may be positioned at ends of the channel section 14. In another example, one or more rollers 18 may be positioned midway along the channel section 14 in order to help support the channel section 14 and assist its movement. The rolling may be accomplished manually by pushing the gate. In another example, the rolling may be accomplished by an electromechanical actuator or other electronic system. Once positioned between the arrestment restraints 16, the movable carriage should not need further restraints. However, it is possible to padlock/key the gate in the closed position if desired.

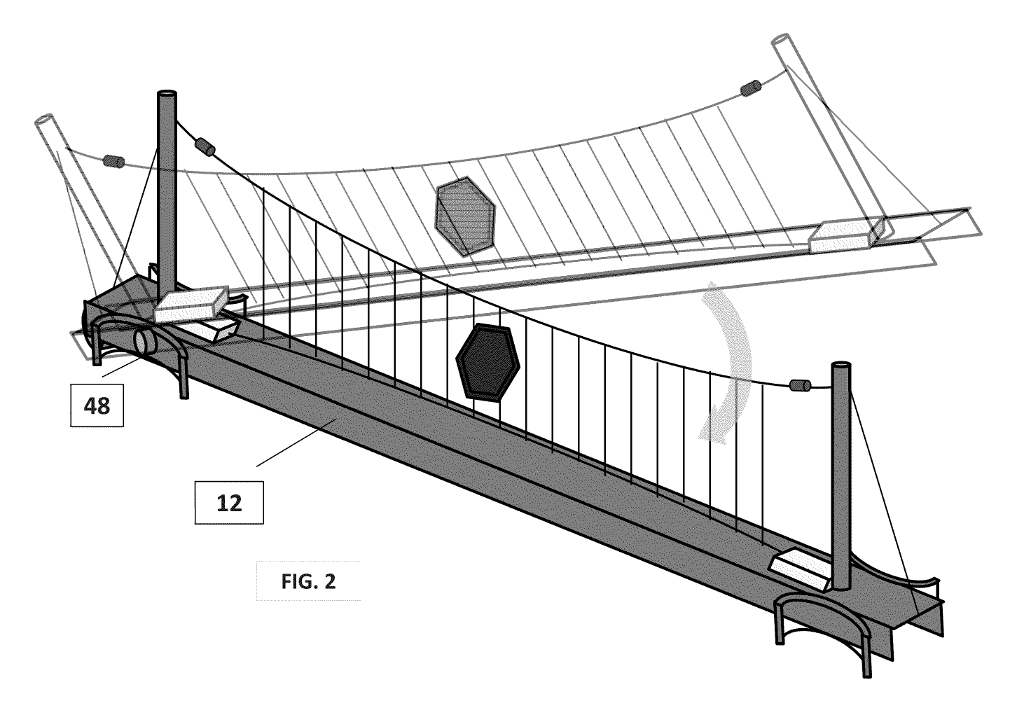

In an alternate embodiment, it is possible for the movable gate carriage 12 to operate via pivoting. One example is illustrated by FIG. 2. As illustrated, the movable gate carriage 12 may be pivoted upwardly with respect to a pivot point 48. This may be done manually or via an electric actuator. For example, the gate carriage 12 may be pivoted down into the entryway/space 60 between arrestment restraints 16. Regardless of which movement system is used, once the gate is properly positioned, the arresting fence system 10 operation works the same.

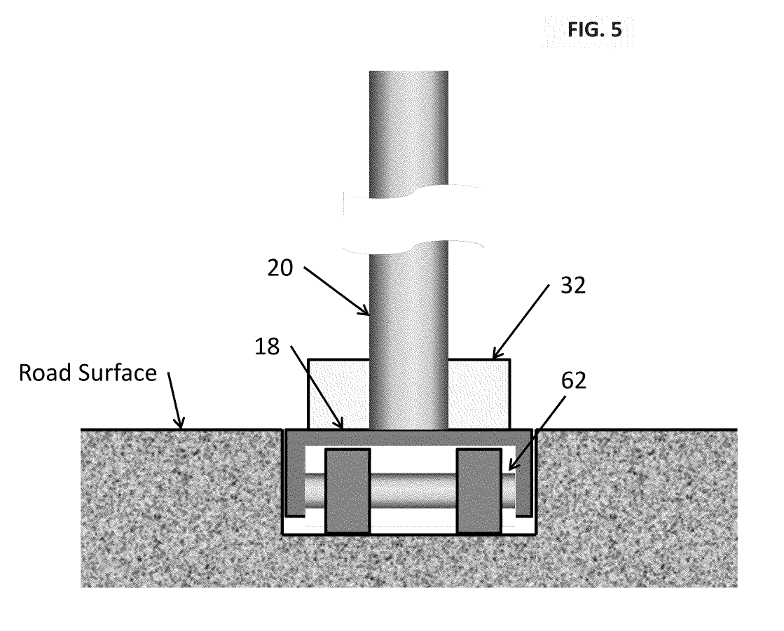

Once the fence 10 has been located in the desired position, the arrestment restraints 16 secure the movable gate carriage 12 in place. The movable gate carriage 12 may travel between the arrestment restraints 16. The restraints 16 may be elements 46 that are anchored in the ground (or anchored to a more complete fencing system 50) and are configured to hold the movable gate carriage 12 in place, opposing the forces imposed during vehicle investment. However, it should be understood that alternate arrestment restraints 16 may be used. For example, as illustrated by FIG. 5, a roadway channel 62 may be formed as a shallow recess in the roadway/road surface. The entire channel section 14/gate carriage 12 may be positioned in the channel 62. In use, the channel 62 serves to restrain the arresting fence system 10 against forces generated via vehicle impact. The roadway channel 62 may replace arrestment restraints 16 by providing a function similar to the support/arrestment they would otherwise provide. When the arresting fence system 10 is not in use, the roadway channel 62 may be covered in order for the road surface to be usable.

The channel section 14 may also have one or more side supports 20 extending therefrom. It is generally expected for two side supports 20 to be present, one positioned on each end of the channel section 14. The side supports 20 are generally positioned along sides of the channel section 14, leaving a central portion 22 to be spanned by an arrestor net 24. The arrestor net 24 may be secured to the side supports 20 using any appropriate securement system. In one example, a support cable 26 may be used to secure the arrestor net 24 to the side support 20. The support cable 26 may have a lower portion secured to the gate carriage 12, may extend over or through or otherwise be secured with respect to the side support 20. The support cable 26 is used to assist in supporting of the side supports 20 against the net weight/catenary forces.

For safety and workability, one or more release mechanisms 40 may be associated with the arrestor net 24. In one example, an upper portion 28 of the arrestor net 24 may be secured to a release mechanism 40. The release mechanism 40 may be secured to the side support 20. In one example, this securement may be via a cable/turnbuckle arrangement attached to an eye bolt on the side support pole 20. In use, the arrestor net 24 will be released from the side supports 20 via the release mechanism 40.

In one example, the release mechanism 40 may be a shear pin arrangement that will release the net at a specified load. The release load is designed to be slightly above the force required to support the net at its design height. Upon vehicle impact, the force is exceeded, and the release mechanism 40 is actuated. In another example, the release mechanism 40 may be a transition zone controller as shown and described by U.S. Pat. No. 8,007,198. In a further example, the release mechanism 40 may be a textile release similar in operation to a textile brake.

It is also possible to provide one or more energy absorbers 32 connected to or otherwise associated with the net 24. The energy absorber 32 is generally designed to have a release load that is a larger than the release load of the release mechanism 40. The general goal of the one or more energy absorbers 32 is to absorb energy from a vehicle impact and provide an appropriate amount of runout space for the vehicle, with the intention of limiting vehicle damage and act and injury.

The one or more energy absorbers 32 may be a textile brake or any other appropriate energy absorber system. For example, an exemplary textile brake may be the Textile Modular Brake manufactured and sold by Zodiac Aerospace Engineered Arresting Systems Corporation, of Aston, PA, the present assignee of this application. In another example, the energy absorber 32 may be a water twister rotary hydraulic energy absorber manufactured and sold by Zodiac Aerospace Engineered Arresting Systems Corporation, of Aston, Pa., the present assignee of this application. In another example, the energy absorber 32 may be a Zodiac Transition Zone Controller (TZC), as described by U.S. Pat. No. 8,007,198 titled “Arresting Systems and Methods.” In another example, the energy absorber 32 may be a friction brake set at a predetermined load. This may be an application of a friction brake or clutch assembly, equipped with a textile tape on a reel. Other energy absorbers 32 are possible for use and are considered within the scope of this disclosure. In any event, the energy absorber 32 may be provided with a predetermined runout based on available space with the intent to stop the vehicle with minimal damage or occupant injury. Parameters that may be adjusted in order to determine the appropriate energy absorber 32 for use in connection with fence system 10 may include but are not limited to vehicle weight, vehicle speed, available runout (vehicle travel) distance, or combinations thereof. The energy absorbers can be configured to provide a vehicle runout as defined by customer requirements, local regulations, or unique installation limitations.

The energy absorber 32 may be mechanically attached to both the net 24 and to the movable gate carriage 12. In the example shown, a lower portion 34 of the net 24 may be secured to or otherwise cooperate with one or more energy absorbers 32. There may be an energy absorber 32 provided at the base of each of the side supports 20. In one example, it is possible for an extension 36 of the energy absorber 32 to form the lower portion 34 of the net 24.

In use, the arresting forces will be transferred from the vehicle to the arrestor net 24, to the energy absorber 32, to the movable gate carriage 12. The position of the movable gate carriage 12 will be maintained due to the arrestment restraints 16 or the roadway channel 62.

An optional frangible channel section 38 may be provided. The optional frangible channel section 38 may reduce the catenary of the arrestor net 24 that would otherwise occur due to gravity and thereby release or reduce loads. The frangible net section 38 may reduce the support tension required in the net suspension and the release mechanism load. It can also provide a visual signal to the driver of the vehicle that the barrier is in place. It can collapse upon vehicle contact with minimal damage to the vehicle. In one example, the frangible channel section 38 may be made from a lightweight material that can easily break. For example, it may be fiberglass or extruded plastic. While the frangible channel section 38 provides vertical support, it is relatively weak in the horizontal direction and fractures upon vehicle impact with the arrestor net 24.

In one example, the frangible channel section 38 includes one or more pins 64 located along its ends, and optionally periodically along the length. These pins 64 may support the upper horizontal portion 28 of the arrestor net 24. These pins 64 may help prevent the net from the sagging. The additional supports along the net links can help reduce the tensile force required to keep the net at the desired height. This, in turn, can reduce the design load on the release mechanism 40, the side support 20, and the support cable 26.

The arrestor net 24 may be manufactured out of any appropriate material that has sufficient strength to arrest a traveling vehicle. In one example, the net may be constructed from nylon 6-6 flat webbing. In another example, the net may be constructed from material currently used by aircraft catch nets. In another example, the net may be manufactured at a higher strength tensile material, such as steel or aramid cable. In another example, the net may be manufactured of a first material and have a second, stronger material interwoven therewith or otherwise incorporated therein.

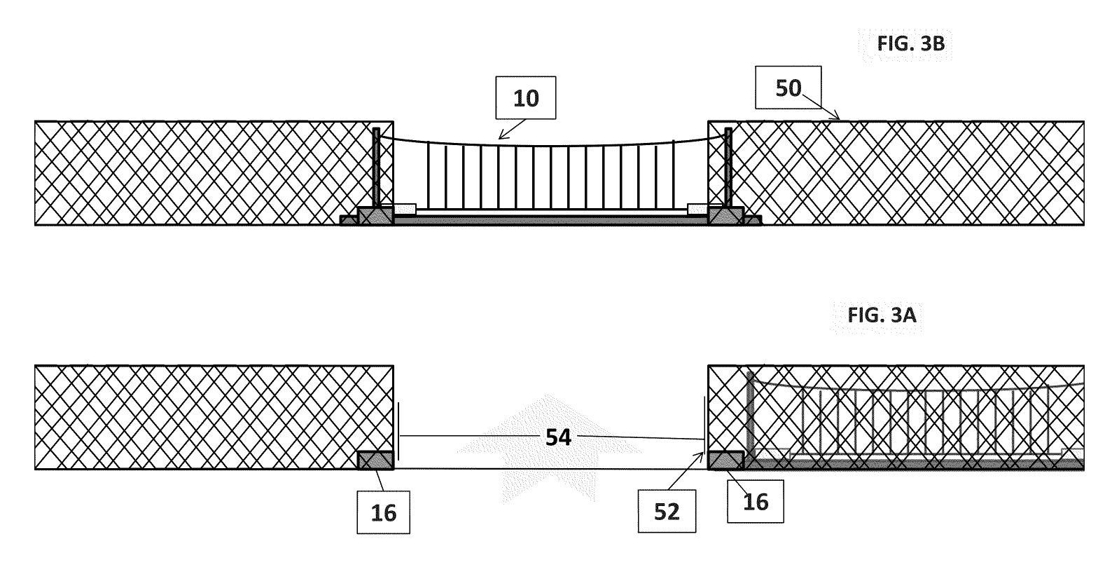

The arresting fence system 10 can provide a barrier that can be incorporated as part of a perimeter fencing system 50, as illustrated by FIG. 3. As shown, the fencing system 50 may have arrestment restraints 16 installed at edges 52. When the fence system 10 is not in use, it may be rolled or pivoted aside to create a clear path 54, illustrated by FIG. 3A. When the fence system 10 is in use, it may be rolled or pivoted to obstruct the clear path, illustrated by FIB. 3B. In another example, the fence system 10 can provide a barrier that can be incorporated as part of a bollard arrangement. The movable gate carriage 12 is designed to move laterally to provide a barrier to entry into the area being protected.

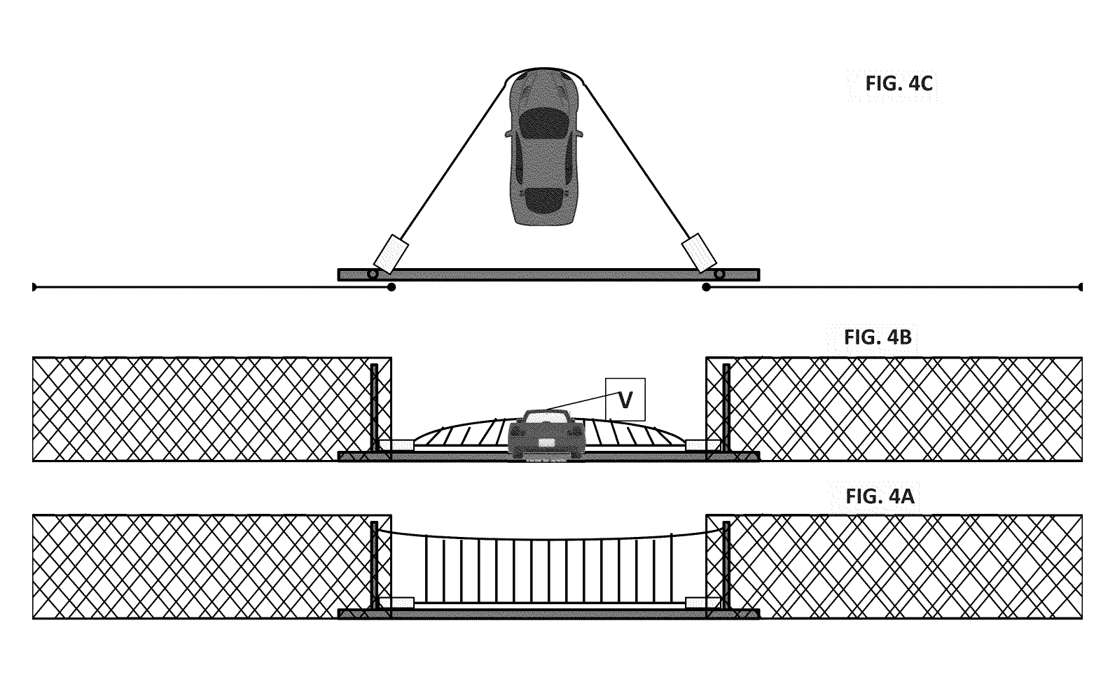

As illustrated by FIG. 4, the sequence of operation of the net may be carried out as follows. These steps may generally occur once the movable gate carriage 12 is positioned in front of the opening 54:
1. The vehicle (V) travels into the arrestor net 24.
2. The release mechanisms 40 on either side of the net 24 release under a design load, allowing the net 24 to envelope and travel with the vehicle.
3. The energy absorbers 32, connected to the net 24, provide a restraining force which is transmitted to the vehicle V until it comes to a stop.
4. The arrestment restraints 16 prevent carriage 12 movement due to the arrestment loads.

It should be understood that other methods of the decelerating a vehicle using the systems described herein are possible. Changes and modifications, additions and deletions may be made to the structures and methods recited above and shown in the drawings without departing from the scope or spirit of the disclosure or the following claims.

What is claimed is:

1. A vehicle arresting system, comprising:
a gate carriage configured for movement into and out of a path to be blocked, the gate carriage comprising:
an arrestor net configured to engage a moving vehicle,
one or more release mechanisms for releasing the arrestor net upon a specified load;
one or more energy absorbers associated with the net; and
one or more gate carriage restraints for securing the gate carriage in place.

2. The system of claim 1, wherein the one or more gate carriage restraints comprise arrestment restraints.

3. The system of claim 1, wherein the one or more gate carriage restraints comprise a roadway channel.

4. The system of claim 1, wherein the gate carriage comprises a movable gate carriage.

5. The system of claim 1, further comprising one or more side supports.

6. The system of claim 1, further comprising a support cable.

7. The system of claim 1, wherein the gate carriage comprises a movable gate carriage comprising one or more rollers.

8. The system of claim 1, wherein the gate carriage comprises a movable gate carriage comprising a pivot point.

9. The system of claim 1, further comprising a frangible channel section positioned with respect to the arrestor net.

10. The system of claim 1, wherein the system is designed to bring a traveling vehicle to a stop through controlled deceleration.

11. The system of claim 1, wherein the gate carriage is designed to move laterally to provide a barrier to entry to an area being protected.

12. The system of claim 11, wherein the barrier is incorporated as part of a perimeter fencing system or a bollard arrangement.

13. The system of claim 1, wherein the energy absorber configuration is adjusted to match the unique arrestment envelope for the installation.

14. The system of claim 13, wherein the energy absorber configuration is adjusted based on vehicle weight, vehicle speed, available runout distance, desired vehicle runout as defined by customer requirements, local regulations, unique installation limitations, or any combination thereof.

15. A method of arresting the vehicle, comprising:
moving a movable arresting system fence into a closed path position;
capturing a movable vehicle via the fence.

16. A vehicle arrestment system for use in connection with a fencing system, comprising:
a movable gate carriage configured for movement into and out of an opening to be blocked defined by the fencing system, the movable gate carriage comprising:
an arrestor net configured to engage a moving vehicle,
one or more release mechanisms for releasing the arrestor net upon a specified load;
one or more energy absorbers associated with the net;
a moving system configured to cause movement of the movable gate carriage into and out of a blocking position with respect to the opening; and
one or more gate carriage restraints for securing the gate carriage in place.

17. The system of claim 16, wherein the one or more gate carriage restraints comprise arrestment restraints secured with respect to fencing system edges.

18. The system of claim 16, wherein the one or more gate carriage restraints comprise a roadway channel positioned between fencing system components.

19. The system of claim 16, wherein the moving system comprises one or more rollers or a gate carriage pivot point.
